(19) United States
(12) Patent Application Publication
(10) Pub. No.: US 2025/0276418 A1
(43) Pub. Date: Sep. 4, 2025

(54) ORBITAL TOOLS

(71) Applicant: Snap-on Incorporated, Kenosha, WI (US)

(72) Inventor: Michael V. LaRosa, Murphy, NC (US)

(73) Assignee: Snap-on Incorporated, Kenosha, WI (US)

(21) Appl. No.: 18/595,050

(22) Filed: Mar. 4, 2024

(51) Int. Cl. B24B 23/04; B25F 5/00; B25F 5/02

(52) U.S. Cl. CPC B24B 23/04; B25F 5/001; B25F 5/026

(57) ABSTRACT

An orbital tool operable in first and second rotational directions, and includes a sprag clutch operably coupled to an output shaft to the tool. When the tool is operated in the first rotational direction, the sprag clutch allows free spinning of an output shaft, thus providing operation in a random orbital mode. When the tool is operated in the second rotational direction, the sprag clutch locks or prevents the output shaft from free spinning, thus providing operation in a rotary mode.

### TECHNICAL FIELD OF THE INVENTION

The present invention relates generally to orbital tools, and more particularly, to orbital tools that operate in different modes based on direction of rotation.

### BACKGROUND OF THE INVENTION

Orbital tools, such as, for example, orbital sanders and/or polishers, are commonly used in automotive, industrial, and household applications to remove material from, smooth, and/or polish a surface. A random orbital sander is one type of orbital tool that operates in a random-orbit action by simultaneously spinning a sanding disk and moving it in overlapping ellipses, while also allowing the sanding disk to free spin. A rotary orbital sander is another type of orbital tool, similar to a random orbital sander. However, the rotary orbital sander operates without allowing the sanding disk to free spin. Therefore, traditionally, multiple different types of tools are required to perform a random orbital polisher/sander related task and a rotary polisher/sander related task.

### SUMMARY OF THE INVENTION

The present invention relates broadly to an orbital tool that is selectively operable in first and second rotational directions. The tool includes a sprag clutch (also known as a one-way bearing, freewheel clutch, cam clutch, or overrunning clutch) operably coupled to an output shaft of the tool. When the tool is operated in the first rotational direction, the sprag clutch allows free spinning of an output shaft, thus providing operation in a random orbital mode. When the tool is operated in the second rotational direction, the sprag clutch locks or prevents the output shaft from free spinning, thus providing operation in a rotary mode.

In an embodiment, the present invention includes an orbital tool including a tool housing having a motor housing portion with a motor housing longitudinal axis and a handle housing portion with a handle housing longitudinal axis, wherein the handle housing longitudinal axis is disposed at an angle of about 90 degrees to 120 degrees relative to the motor housing longitudinal axis. Thus, the tool housing forms a pistol-type grip tool. A motor is disposed in the motor housing portion and includes a motor shaft, wherein the motor is adapted to selectively rotate the motor shaft in either of first and second rotational directions. A balancer may be operably coupled to the motor shaft, and an output shaft is disposed in the balancer. A sprag clutch is also disposed in the balancer and operably coupled to the output shaft, wherein the sprag clutch is adapted to allow rotation of the output shaft relative to the balancer when the motor shaft is selectively rotated in the first rotational direction, and prevent rotation of the output shaft relative to the balancer when the motor shaft is selectively rotated in the second rotational direction.

In another embodiment, the present invention includes an orbital tool including a tool housing, a nose housing including an illumination element and that is coupled to the tool housing, and a motor disposed in the tool housing and including a motor shaft, wherein the motor is adapted to selectively rotate the motor shaft in either of first and second rotational directions. A balancer is operably coupled to the motor shaft, an output shaft is disposed in the balancer, and a sprag clutch is disposed in the balancer and operably coupled to the output shaft, wherein the sprag clutch is adapted to allow rotation of the output shaft relative to the balancer when the motor shaft is rotated in the first rotational direction, and prevent rotation of the output shaft with respect to the balancer when the motor shaft is rotated in the second rotational direction.

In another embodiment, the present invention includes an orbital tool including a housing and a motor disposed in the housing and including a motor shaft, wherein the motor is adapted to selectively rotate the motor shaft in either of first and second rotational directions. A balancer is operably coupled to the motor shaft, a counterbalance is coupled to an exterior surface of the balancer, an output shaft is disposed in the balancer, and a sprag clutch is disposed in the balancer and operably coupled to the output shaft. The sprag clutch is adapted to allow rotation of the output shaft relative to the balancer when the motor shaft is rotated in the first rotational direction, and prevent rotation of the output shaft relative to the balancer when the motor shaft is rotated in the second rotational direction.

### BRIEF DESCRIPTION OF DRAWINGS

For the purpose of facilitating an understanding of the subject matter sought to be protected, there is illustrated in the accompanying drawing embodiments thereof, from an inspection of which, when considered in connection with the following description, the subject matter sought to be protected, its construction and operation, and many of its advantages, should be readily understood and appreciated.

FIG. 1 is perspective view of an exemplar orbital tool, incorporating an embodiment of the present invention.

FIG. 2 is a first side view of the orbital tool of FIG. 1.

FIG. 3 is a second side view of the orbital tool of FIG. 1.

FIG. 4 is a partial exploded, perspective view of the orbital tool of FIG. 1.

FIG. 5 is an exploded, perspective view of the orbital tool of FIG. 1.

FIG. 6 is a perspective view of internal components of the orbital tool of FIG. 1.

FIG. 7 is an exploded perspective view of components of the orbital tool of FIG. 1.

FIG. 8 is an exploded perspective view of output components of the orbital tool of FIG. 1.

FIG. 9 is a cross sectional view of the output components of the orbital tool of FIG. 8 assembled together.

FIG. 10 is a cross sectional view of another embodiment of output components of the orbital tool, according to an embodiment of the present invention.

FIG. 11 is a cross sectional view of another embodiment of output components of the orbital tool, according to an embodiment of the present invention.

### DETAILED DESCRIPTION OF THE INVENTION

While the present invention is susceptible of embodiments in many different forms, there is shown in the drawings, and will herein be described in detail, a preferred embodiment of the invention with the understanding that the present disclosure is to be considered as an exemplification of the principles of the invention and is not intended to limit the broad aspect of the invention to embodiments illustrated. As used herein, the term “present invention” is not intended to limit the scope of the claimed invention and is instead a term used to discuss exemplary embodiments of the invention for explanatory purposes only.

The present invention relates broadly to an orbital tool that is selectively operable in first and second rotational directions. The tool includes a sprag clutch (also known as a one-way bearing, freewheel clutch, cam clutch, or overrunning clutch) operably coupled to an output shaft of the tool. When the tool is operated in the first rotational direction, the sprag clutch allows free spinning of an output shaft, thus providing operation in a random orbital mode. When the tool is operated in the second rotational direction, the sprag clutch locks or prevents the output shaft from free spinning, thus providing operation in a rotary mode.

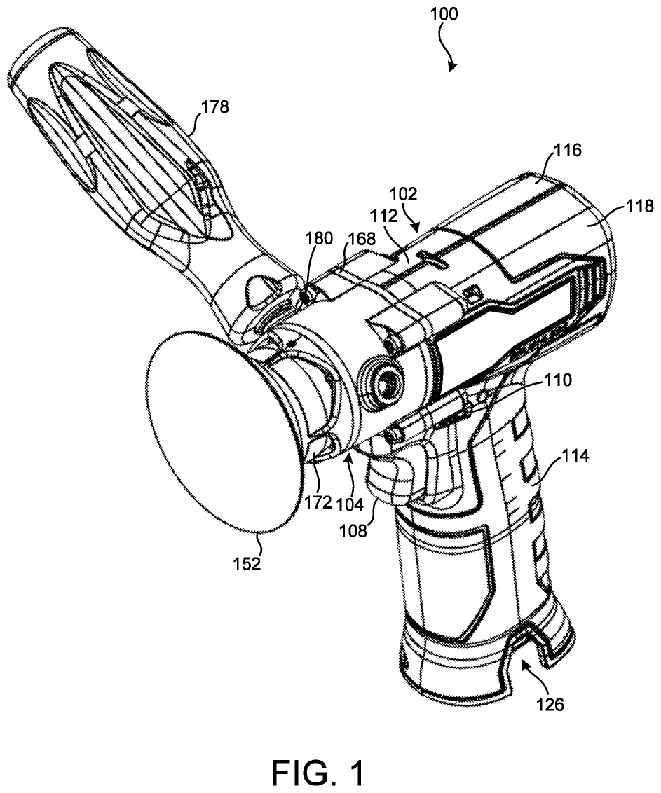

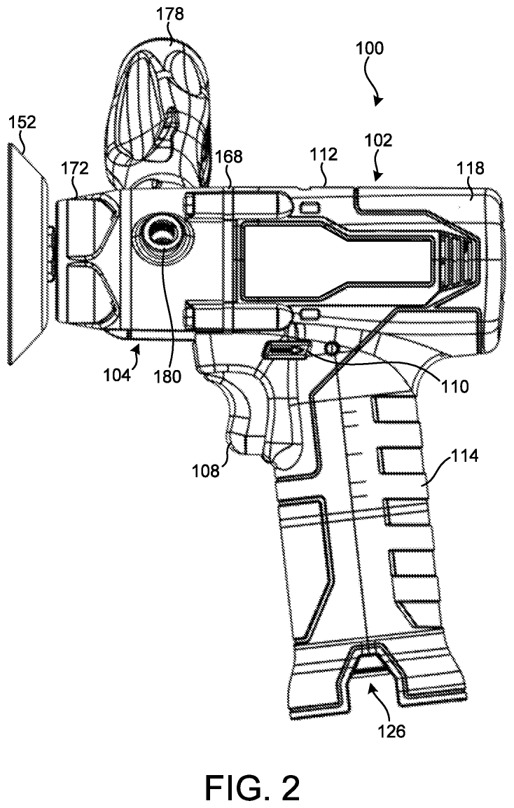

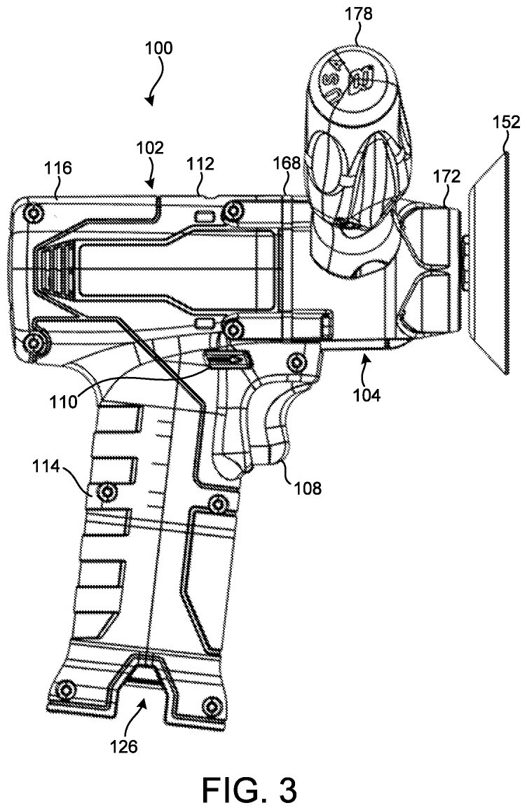

Referring to FIGS. 1-6, an exemplary tool 100, such as an orbital sander/polisher sander, incorporating an embodiment of the present invention is illustrated. The tool 100 includes a tool housing 102, an output assembly 104 operably coupled to the tool housing 102, a motor 106 disposed in the tool housing 102 and operably coupled to the output assembly 104, a trigger 108 operably coupled to the motor 106 and actuatable to operate the motor 106 and thereby the output assembly 104, and a direction selector switch 110 adapted to select the rotational direction of the motor 106. The tool housing 102 includes a motor housing portion 112 and a handle housing portion 114. The motor housing portion 112 is adapted to house the motor 106. The handle housing portion 114 extends from the motor housing portion 112. As illustrated, the tool 100 is a pistol grip style tool, and the motor housing portion 112 and handle housing portion 114 may be disposed at an angle relative to each other. For example, a motor housing longitudinal axis of the motor housing portion 112 and a handle housing longitudinal axis of the handle housing portion 114 may be disposed at an angle of about 90 to about 120 degrees, and more particularly about 110 degrees, relative to each other. In an example, the tool housing 102 may include first and second housing portions 116, 118 (respectively forming first and second sides of the housing 102) that are coupled together in a clamshell type manner and coupled to the output assembly 104. In another example, the tool housing 102 (including the first and second housing portions 116, 118) may be a single integrated or monolithic piece.

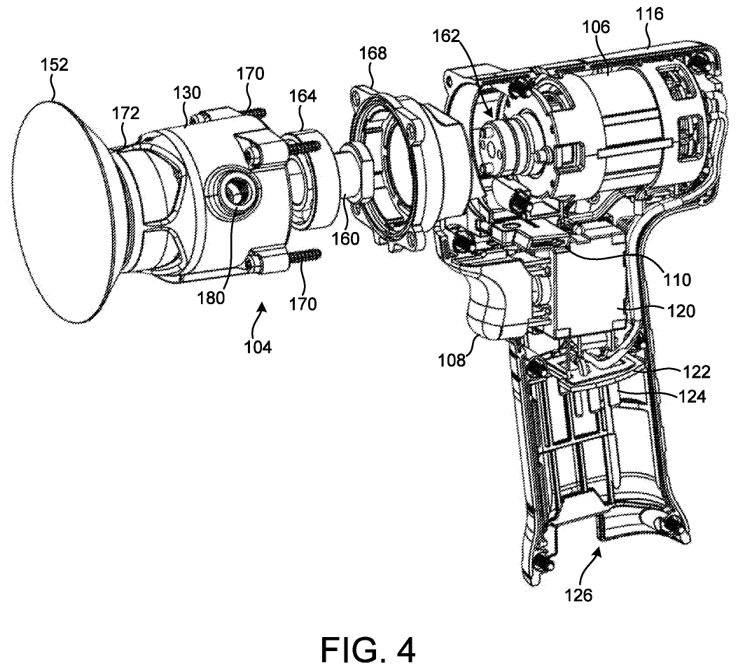

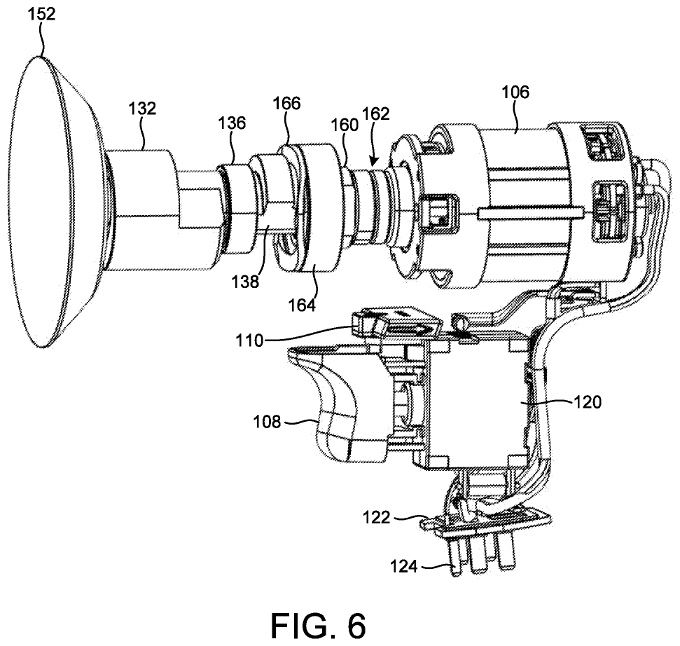

Referring to FIGS. 4 and 6, the tool housing 102 may enclose or house internal components of the tool 100, such as the motor 106, switch assembly 120, motor control electronics and/or controller 122 (which may be incorporated into the switch assembly 120 or separate), and power source components, such as terminals 124 adapted to operably couple to a battery, such as a rechargeable type battery) that may be received in a battery receiving portion 126 of the tool housing 102. The tool may also include other components, such as a display for configuring the tool and/or providing operational information about the tool (such as, for example, speed, battery level, etc.), one or more indicators such as light emitting diodes, and other components for operation of the tool, for example. The tool housing 102 may also include a textured grip to improve a user's grip of the tool 100 during use.

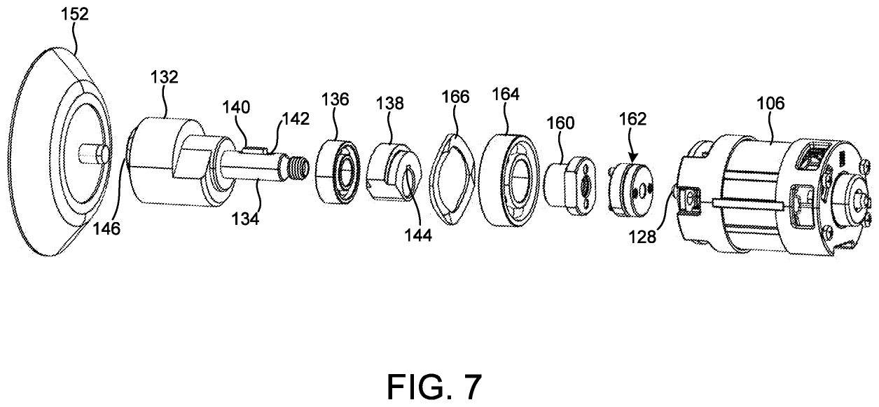

The motor 106 is disposed in and supported in the tool housing 102 and operably coupled to the trigger 108 via the switch assembly 120. The motor 106 includes a motor shaft 128 (as shown in FIG. 7) that is operably coupled to the output assembly 104, as described below. Thus, actuation of the trigger 108 by a user causes the motor 106 to operate and rotate the output assembly 104 in a desired rotational direction, based on a position of the direction selector switch 110.

The motor 106 may be a brushless (BLDC) or brushed type motor, or any other suitable motor. A power source can be associated with the tool 100 to provide electric or other forms of power to the tool 100, such as, for example, hydraulic, or pneumatic, to operate the motor 106. In an embodiment, the power source (not shown) can be housed in the battery receiving portion 126 of the tool housing 102, or any other portion of the tool 100/tool housing 102. The power source may also be an external component that is not housed by the tool 100, but that is operatively coupled to the tool 100 through, for example, hoses, wires, or wireless means. In an embodiment, the power source is a removable and rechargeable battery that is adapted to be disposed in the battery receiving portion 126 of the tool housing 102 and electrically coupled to corresponding terminals 124 of the tool 100.

In an example, the motor 106 is a brushless DC (BLDC) motor, and the tool 100 includes motor control electronics and/or controller(s) 122 (which may be incorporated into the switch assembly 120 or separate) operably coupled to and adapted to control the motor 106. For example, referring to FIGS. 4 and 6, the motor control electronics 122 may include a printed circuit board (PCB) including one or more switching elements disposed thereon. The switching elements may be field effect transistors (FETs), such as, for example, metal-oxide semiconductor field-effect transistors (MOSFETs). In an embodiment, the switching elements may include three high-side switching elements, H1, H2, and H3, and three low-side switching elements, L1, L2, and L3, each being operable in either one of a first or conducting state and a second or non-conducting state. The switching elements are controlled by the PCB to selectively apply power from a power source (e.g., a battery pack) to the motor 106 to achieve desired commutation. By selectively activating particular high-side and low-side switching elements, the motor 106 is operated by having the motor control electronics or controller 122 send an electric current through coils located on a stationary part of the motor 106, called a stator. The coils cause a magnetic force to be applied to a rotating part of the motor 106, called a rotor, when electric current runs through the coils. The rotor contains permanent magnets that interact with the magnetic forces caused by windings of the stator. By selectively activating successive combinations of high and low-side switching elements in a particular order, thereby sending a particular order of current through the windings of the stator, the stator creates a rotating magnetic field which interacts with the rotor causing it to rotate, which causes rotation of the motor shaft 128 in a desired direction and at a desired speed, in a well-known manner.

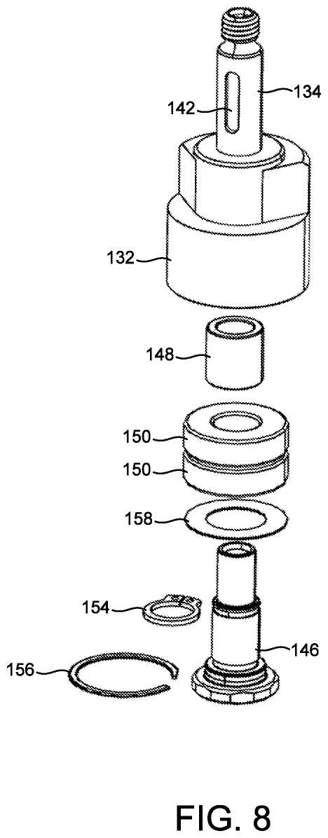

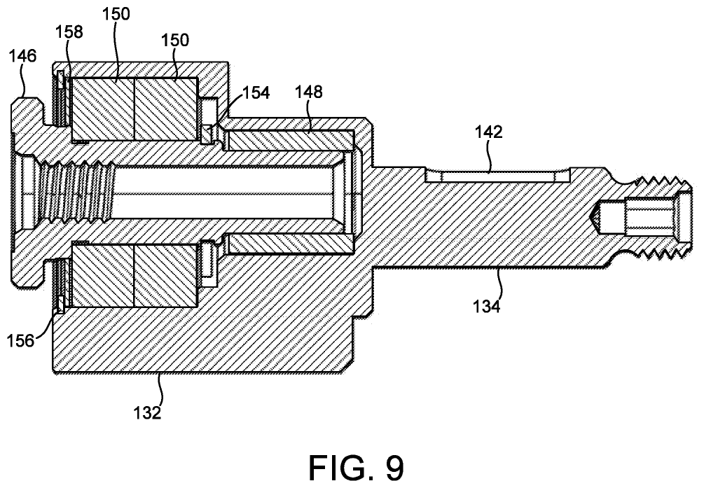

Referring to FIGS. 4-9, the output assembly 104 includes an output assembly housing 130 that houses components of the output assembly 104. The components may include a balancer 132 with a balancer shaft 134 operably coupled to the motor shaft 128, and a bearing 136 disposed around an exterior surface of the balancer shaft 134 to facilitate rotation of the balancer shaft 134 relative to the output assembly housing 130. A counterbalance 138 may also be disposed on the exterior surface of the balancer shaft 134 and co-rotate with the balancer 132. For example, the counterbalance 138 may be coupled to the balancer shaft 134 via a keyed engagement that includes a key 140 disposed in corresponding grooves 142, 144 of the respective balancer shaft 134 and the counterbalance 138.

The output assembly 104 may also include an output shaft 146 disposed in the balancer 132, a sprag clutch 148 (also known as a one-way bearing, freewheel clutch, cam clutch, or overrunning clutch) disposed on the output shaft 146, and optionally one or more bearings 150 disposed on the output shaft 146. An accessory 152, such as, for example, a backing pad, replaceable polishing pads or discs, or abrasive attachments (such as sanding pads or discs, etc.), or other type of accessory, may be coupled to and end of the output shaft 146.

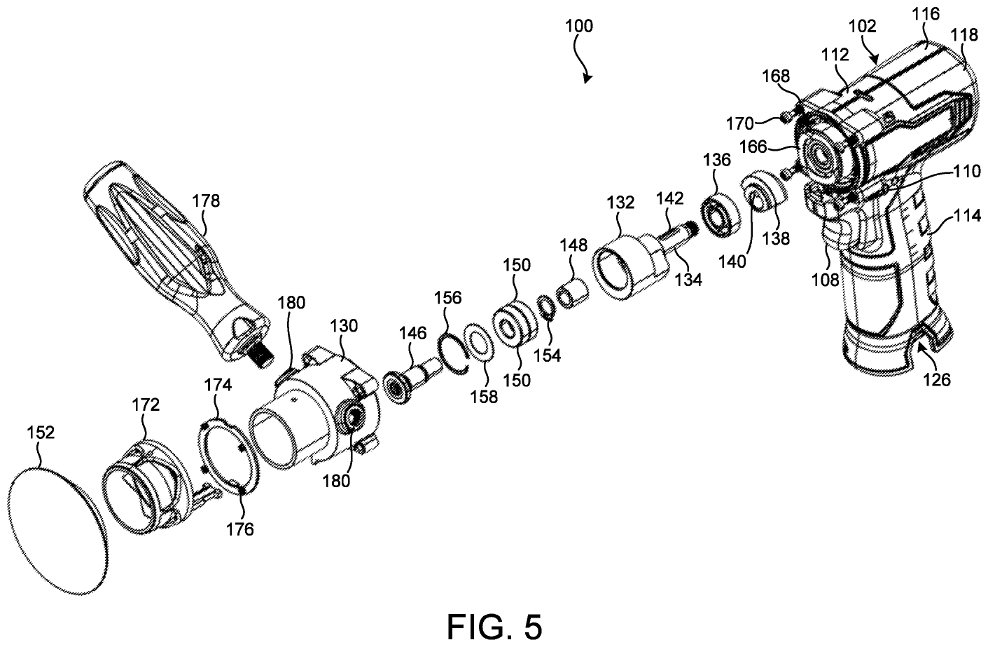

The sprag clutch 148 and optional bearings 150 may be disposed on an exterior surface of the output shaft 146 or otherwise operably coupled to the output shaft 146. For example, referring to FIGS. 5, 8, and 9, the sprag clutch 148 may be disposed on the output shaft 146 proximal to an end of the output shaft 146 opposite the accessory 152, and the output shaft 146 retained in the balancer 132, via the bearings 150 by a retaining ring 154 disposed in a groove in the output shaft 146 between the bearings 150 and the sprag clutch 148. The bearings 150 may be disposed on the output shaft 146 proximal to an end of the output shaft 146 proximal to the accessory 152, and the bearings 150 retained on the output shaft 146 and in the balancer 132 by a retaining ring 156 and washer 158, where the retaining ring 156 is disposed in a groove in an interior surface of the balancer 132. Thus, the bearings 150 may be sandwiched between the retaining ring 156 and washer 158 and the retaining ring 154.

The sprag clutch 148 and optional bearings 150 may also be in contact with the interior surface of the balancer 132. The sprag clutch 148 allows the output shaft 146 to rotate relative to the balancer 132 when the balancer 132 is rotated (via operation of the motor 106) in a first rotational direction, and prevents the output shaft 146 from rotating relative to the balancer 132 when the balancer 132 is rotated in a second rotational direction opposite of the first rotational direction. Thus, when the tool 100 is operated in the first direction, the sprag clutch 148 allows free spinning of the output shaft 146, thus providing operation in a random orbital mode. When the tool 100 is operated in the second direction, the sprag clutch 148 locks or prevents the output shaft 146 from free spinning, thus providing operation in a rotary mode.

The output assembly 104 may be operably coupled to the motor shaft 128 via one or more other components. For example, a shaft extension 160 may be coupled to an end of the balancer shaft 134 proximal to the motor 106 and operably coupled to the motor shaft 128 via one or more spacers 162. A bearing 164 may also be disposed on an exterior surface of the shaft extension 160 to facilitate rotation of the shaft extension 160 relative to the output assembly housing 130. A spring washer 166 may also be disposed between the bearing 164 and the counterbalance 138. The tool housing 102 may also include a middle housing portion 168 that houses one or more of the components and facilitates coupling of the output assembly housing 130 to the motor housing portion 112. For example, the output assembly housing 130, middle housing portion 168, and motor housing portion 112 may be coupled together via one or more fasteners 170.

The supply of power to the motor 106 may be controlled by the trigger 108. As illustrated, the trigger 108 is disposed in and extends from the handle housing portion 114 proximal to the motor housing portion 112. The trigger 108 can be actuated by a user to cause power to be supplied from the power source to the motor 106 to drive the motor 106 (and motor shaft 128) in either one of first and second rotational directions (e.g., clockwise and counterclockwise). The trigger 108 can be biased, such that a user can depress the trigger 108 inwardly, relative to the tool 100, to cause the tool 100 to operate, and release the trigger 108, wherein the biased nature of the trigger 108 causes the trigger 108 to move outwardly, relative to the tool 100, to cease operation of the tool 100.

The trigger 108 may also be operably coupled to the switch assembly 120 and motor control electronics 124 to cause power to be supplied from the power source to the motor 106 when the trigger 108 is actuated. Additionally, the trigger 108 and/or switch assembly 120 may also include a variable speed type mechanism. In this regard, actuation of the trigger 108 causes the motor 106 to operate at a faster speed the further the trigger 108 is actuated. However, any suitable trigger 108 or switch assembly 120 can be implemented without departing from the spirit and scope of the present invention.

The tool 100 may also include a direction selector switch 110 that is actuatable via one or more buttons between first and second positions, to allow a user to select either one of first or second rotational directions (e.g., clockwise and counterclockwise). As illustrated, the direction selector switch 110 is disposed above the trigger 108, and extends out of the handle housing portion 114, on opposing sides proximal to the motor housing portion 112. When the direction selector switch 110 is in the first position, the first rotational direction is selected, and when the direction selector switch 110 is in the second position, the second rotational direction is selected. Selection of the first rotational direction causes the motor 106 to rotate the motor shaft 128 in the first direction, such as clockwise. Similarly, selection of the second rotational direction causes the motor 108 to rotate the motor shaft 128 in the second direction opposite the first direction, such as counterclockwise.

During operation, when the direction selector switch 110 is in the first position and the trigger 108 is actuated, power is supplied from the power source to the motor 106 to drive the motor 106 (and motor shaft 128) in the first rotational direction. Rotation of the motor shaft 128 causes rotation of the balancer 132 in the first rotational direction, which rotates the accessory 152 via the output shaft 146. When the tool 100 is operated in the first rotational direction, the sprag clutch 148 allows free spinning of the output shaft 146 relative to the balancer 132, providing operation in a random orbital mode.

Similarly, when the direction selector switch 110 is in the second position and the trigger 108 is actuated, power is supplied from the power source to the motor 106 to drive the motor 106 (and motor shaft 128) in the second rotational direction. Rotation of the motor shaft 128 causes rotation of the balancer 132 in the second rotational direction, which rotates the accessory 152 via the output shaft 146. When the tool 100 is operated in the second rotational direction, the sprag clutch 148 locks/prevents free spinning of the output shaft 146 relative to the balancer 132, thus providing operation in a rotary mode.

While the sprag clutch 148 is described as allowing free spinning of the output shaft 146 relative to the balancer 132 when the tool 100 is operated in the first rotational direction, and locking/preventing the output shaft 146 from free spinning relative to the balancer 132 when the tool 100 is operated in the second rotational direction, it will be appreciated that operation of the sprag clutch 148 may be reversed. For example, the sprag clutch 148 may allow free spinning of the output shaft 146 relative to the balancer 132 when the tool 100 is operated in the second rotational direction, and lock/prevent the output shaft 146 from free spinning relative to the balancer 132 when the tool 100 is operated in the first rotational direction.

The tool 100 may also include a nose housing 172 with illuminating elements coupled to the output assembly housing 130 to provide light to the work area. For example, the nose housing 172 may be coupled to the output assembly housing 130 and middle housing 168 via a clip that extends into grooves in the output assembly housing 130 and middle housing 168. A light circuit board 174 with one or more light emitting diodes (LEDs) 176 may be disposed in the nose housing 172 and on the exterior surface of the output assembly housing 130, and operably coupled to the power source, such as via the switch assembly 120. Thus, when the trigger 108 is actuated, power may also be supplied to the light circuit board 174 and LEDs 176 to cause the LEDs 176 to illuminate. The light circuit board 174 may also control the LEDs 176 with a timer. So, for example, when the trigger 108 is released, the LEDs 176 may remain illuminated a predetermined amount of time, for example 5 seconds. Alternately, partial actuation of the trigger 108, but before the motor 106 is provided power, may cause the LEDs 176 to illuminate. Alternately, a separate switch may also be provided to operate the LEDs. The LEDs 176, when illuminated, in combination with the nose housing 172, direct light to illuminate an area of a work surface when the tool 100 is being operated.

The tool 100 may also include an auxiliary handle 178 for facilitating two-handed operation of the tool 100 to provide better stability during use of the tool 100. The auxiliary handle 178 may be optionally coupled to one or more handle coupling locations 180 on an exterior surface of the output assembly housing 130. For example, the output assembly housing 130 may include at least two coupling locations 180 in the form of threaded apertures, and the auxiliary handle 178 may be independently coupled to either coupling location 180 by threadably engaging the auxiliary handle 178 with the threaded apertures.

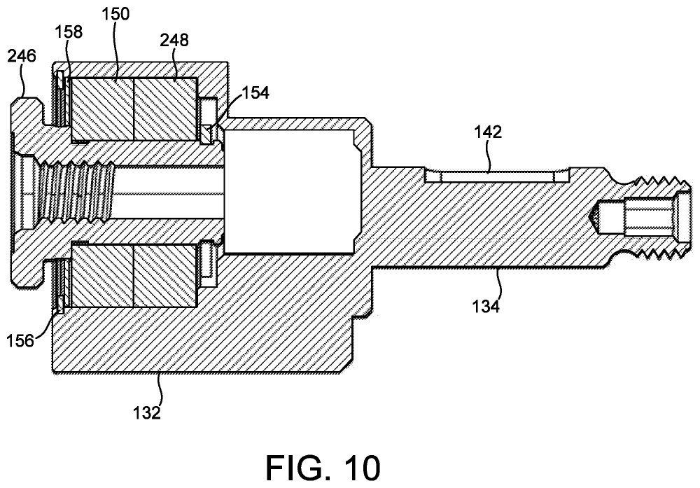

In another embodiment, referring to FIG. 10, the output assembly 104 may include an output shaft 246 (instead of the output shaft 146) disposed in the balancer 132, a sprag clutch 248 (instead of the sprag clutch 148) disposed on the output shaft 246, and optionally one or more bearings 150 disposed on the output shaft 246. In this embodiment, the sprag clutch 248 and optional bearings 150 may be disposed on an exterior surface of the output shaft 246 or otherwise operably coupled to the output shaft 246 and sandwiched between the retaining ring 156 and washer 158 and the retaining ring 154. The sprag clutch 248 and optional bearings 150 may also be in contact with the interior surface of the balancer 132.

Like sprag clutch 148, sprag clutch 248 allows the output shaft 246 to rotate relative to the balancer 132 when the balancer 132 is rotated (via operation of the motor 106) in a first direction, and prevents the output shaft 246 from rotating relative to the balancer 132 when the balancer 132 is rotated in a second direction. Thus, when the tool 100 is operated in the first direction, the sprag clutch 248 allows free spinning of the output shaft 246, thus providing operation in a random orbital mode. When the tool 100 is operated in the second direction, the sprag clutch 248 locks/prevents the output shaft 246 from free spinning, thus providing operation in a rotary mode.

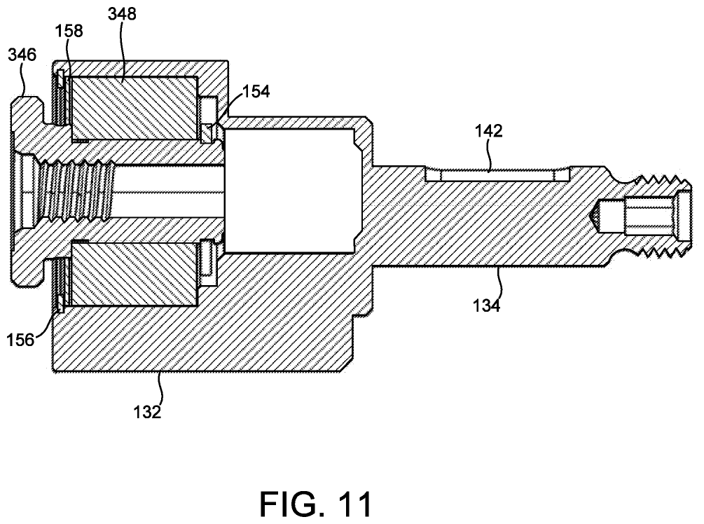

In another embodiment, referring to FIG. 11, the output assembly 104 may include an output shaft 346 (instead of output shaft 146) disposed in the balancer 132 and a sprag clutch 348 (instead of sprag clutch 148) disposed on the output shaft 346. In this embodiment, the sprag clutch 348 may be disposed on an exterior surface of the output shaft 346 or otherwise operably coupled to the output shaft 346 and sandwiched between the retaining ring 156 and washer 158 and the retaining ring 154. The sprag clutch 348 may also be in contact with the interior surface of the balancer 132. Like sprag clutch 148, sprag clutch 348 allows the output shaft 346 to rotate with respect to the balancer 132 when the balancer 132 is rotated (via operation of the motor 106) in a first direction, and prevents the output shaft 346 from rotating relative to the balancer 132 when the balancer 132 is rotated in a second direction. Thus, when the tool 100 is operated in the first direction, the sprag clutch 348 allows free spinning of the output shaft 346, thus providing operation in a random orbital mode. When the tool 100 is operated in the second direction, the sprag clutch 348 locks/prevents the output shaft 346 from free spinning, thus providing operation in a rotary mode.

As discussed herein, the tool 100 can be an electric tool, such as, for example, a polisher and/or sander. However, it will be appreciated that the tool 100 can alternatively be pneumatically or hydraulically powered.

As used herein, the term “coupled” and its functional equivalents are not intended to necessarily be limited to direct, mechanical coupling of two or more components. Instead, the term “coupled” and its functional equivalents are intended to mean any direct or indirect mechanical, electrical, or chemical connection between two or more objects, features, work pieces, and/or environmental matter. “Coupled” is also intended to mean, in some examples, one object being integral with another object. As used herein, the term “a” or “one” may include one or more items unless specifically stated otherwise.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of the inventors' contribution. The actual scope of the protection sought is intended to be defined in the following claims when viewed in their proper perspective based on the prior art.

What is claimed is:

1. An orbital tool, comprising:
a tool housing including a motor housing portion with a motor housing longitudinal axis and a handle housing portion with a handle housing longitudinal axis, wherein the handle housing longitudinal axis is disposed at an angle of about 90 degrees to 120 degrees relative to the motor housing longitudinal axis;
a motor disposed in the motor housing portion and including a motor shaft, wherein the motor is adapted to selectively cause the motor shaft to rotate in either of first and second rotational directions;
a balancer operably coupled to the motor shaft;
an output shaft disposed in the balancer; and
a sprag clutch disposed in the balancer and operably coupled to the output shaft, wherein the sprag clutch is adapted to allow rotation of the output shaft relative to the balancer when the motor shaft is rotated in the first rotational direction, and prevent rotation of the output shaft relative to the balancer when the motor shaft is rotated in the second rotational direction.

2. The orbital tool of claim 1, further comprising a bearing disposed in the balancer and operably coupled to the output shaft.

3. The orbital tool of claim 1, further comprising a counterbalance coupled to an exterior surface of the balancer.

4. The orbital tool of claim 3, wherein the counterbalance is coupled to the balancer via a keyed engagement.

5. The orbital tool of claim 4, wherein the keyed engagement includes a key disposed in corresponding grooves of the balancer and the counterbalance.

6. The orbital tool of claim 1, further comprising an auxiliary handle adapted to be coupled to the tool.

7. The orbital tool of claim 1, further comprising a backing pad coupled to the output shaft.

8. An orbital tool, comprising:
a tool housing;
a nose housing including an illumination element and coupled to the tool housing;
a motor disposed in the tool housing and including a motor shaft, wherein the motor is adapted to selectively cause the motor shaft to rotate in either of first and second rotational directions;
a balancer operably coupled to the motor shaft;
an output shaft disposed in the balancer; and
a sprag clutch disposed in the balancer and operably coupled to the output shaft, wherein the sprag clutch is adapted to allow rotation of the output shaft relative to the balancer when the motor shaft is rotated in the first rotational direction, and prevent rotation of the output shaft relative to the balancer when the motor shaft is rotated in the second rotational direction.

9. The orbital tool of claim 8, wherein the tool housing includes a motor housing portion with a motor housing longitudinal axis and a handle housing portion with a handle housing longitudinal axis, wherein the handle housing longitudinal axis is disposed at an angle of about 90 degrees to 120 degrees relative to the motor housing longitudinal axis.

10. The orbital tool of claim 8, further comprising a counterbalance coupled to an exterior surface of the balancer.

11. The orbital tool of claim 10, wherein the counterbalance is coupled to the balancer via a keyed engagement.

12. The orbital tool of claim 11, wherein the keyed engagement includes a key disposed in respective corresponding grooves of the balancer and the counterbalance.

13. The orbital tool of claim 8, further comprising an auxiliary handle adapted to be coupled to the tool.

14. The orbital tool of claim 8, further comprising a backing pad coupled to the output shaft.

15. An orbital tool, comprising:
a housing including a handle housing portion;
a motor disposed in the housing and including a motor shaft, wherein the motor is adapted to cause the motor shaft to rotate in either of first and second rotational directions;
a balancer operably coupled to the motor shaft;
a counterbalance coupled to an exterior surface of the balancer;
an output shaft disposed in the balancer; and
a sprag clutch disposed in balancer and operably coupled to the output shaft, wherein the sprag clutch is adapted to allow rotation of the output shaft relative to the balancer when the motor shaft is rotated in the first rotational direction, and prevent rotation of the output shaft relative to the balancer when the motor shaft is rotated in the second rotational direction.

16. The orbital tool of claim 15, further comprising a bearing disposed in the balancer and operably coupled to the output shaft.

17. The orbital tool of claim 15, further comprising an auxiliary handle adapted to be coupled to the tool.

18. The orbital tool of claim 15, further comprising a backing pad coupled to the output shaft.

19. The orbital tool of claim 15, further comprising a trigger operably coupled to the motor, wherein actuation of the trigger is adapted to cause power to be supplied to the motor.

20. The orbital tool of claim 15, further comprising a direction selector switch operably coupled to the motor and actuatable to select either of the first and second rotational directions.
